(19) United States
(12) Patent Application Publication
(10) Pub. No.: US 2016/0021239 A1
(43) Pub. Date: Jan. 21, 2016

(54) COMMUNICATION SYSTEM, COMMUNICATION DEVICE, NETWORK PARAMETER CONTROL METHOD, AND NON-TRANSITORY COMPUTER READABLE MEDIUM

(71) Applicant: NEC Corporation, Tokyo (JP)

(72) Inventor: Takanori IWAI, Tokyo (JP)

(21) Appl. No.: 14/767,951

(22) PCT Filed: Jan. 29, 2014
(86) PCT No.: PCT/JP2014/000451

§ 371 Date: Aug. 14, 2015

(30) Foreign Application Priority Data
Feb. 15, 2013 (JP) 2013-028459

(51) Int. Cl. H04M 1/725; H04W 4/04; H04W 4/00

(52) U.S. Cl. CPC H04M 1/72577; H04W 4/005; H04W 4/046

(57) ABSTRACT

A communication system capable of executing optimization of network processing based on a change in utilization characteristics is provided. The mobile communication system according to the present invention includes a network operator device (12) that is arranged in a communication network managed by a communication provider and a communication device (11) that performs communication via the communication network. The communication device (11) transmits network assist information to the network operator device (12), the network assist information being used to change a network parameter associated with the communication device upon detecting a state change in the communication device. The network operator device (12) changes the network parameter associated with the communication device (11) based on the network assist information transmitted from the communication device (11).

### TECHNICAL FIELD

The present invention relates to a mobile communication system that determines a control content based on an event content regarding which a notification is sent from a communication device.

### BACKGROUND ART

In recent years, a method for optimizing setting of each processing node forming a mobile communication system has been required. In the 3GPP, a method for optimizing network processing according to utilization characteristics of a mobile communication terminal has been proposed (Non-Patent Literature 1). For example, for a terminal fixedly installed in a specific location, network processing may be executed to reduce control processing regarding a movement. Specifically, the intervals at which the terminal executes location registration may be set longer than a predetermined period of time. Further, when the mobile communication terminal is a terminal that permits a delay, network processing may be executed to transmit data to a mobile terminal in such a way as to control communication time to avoid the timing at which the amount of data to be transmitted and received becomes the largest.

### CITATION LIST

Non Patent Literature
[Non-Patent Literature 1] 3GPP TS 22.368 V11.3.0 (2011 September) 3rd Generation Partnership Project; Technical Specification Group Services and System Aspects; Service requirements for Machine-Type Communications(MTC); Stage 1 (Release 11)

### SUMMARY OF INVENTION

### Technical Problem

However, as described above, the optimization of the network processing is executed for a mobile terminal whose utilization characteristics are fixed. For example, whether the terminal is fixedly installed in a specific location or permits a delay is determined using predetermined terminal information, predetermined terminal service information or the like. It is now required to execute, in addition to the optimization of the network processing stated above, optimization of network processing for a mobile terminal whose utilization characteristics change. It is therefore required to execute optimization of the network processing using information other than service information or the like which generally changes less frequently.

One exemplary object of the present invention is to provide a communication system, a communication device, a network parameter control method, and a program that solve the aforementioned problem.

### Solution to Problem

A communication system according to a first exemplary aspect of the present invention includes a network operator device that is arranged in a communication network managed by a communication provider and a communication device that performs communication via the communication network, in which: the communication device transmits network assist information to the network operator device, the network assist information being used to change a network parameter associated with the communication device upon detecting a state change in the communication device, and the network operator device changes the network parameter associated with the communication device based on the network assist information transmitted from the communication device.

A communication device according to a second exemplary aspect of the present invention communicates with a network operator device via a communication network, the network operator device being arranged in the communication network managed by a communication provider, in which the communication device includes a communication unit that transmits network assist information to the network operator device, the network assist information being used to change a network parameter associated with the communication device upon detecting a state change in the communication device.

A network parameter control method according to a third exemplary aspect of the present invention includes transmitting network assist information to a network operator device, the network assist information being used to change a network parameter associated with a communication device in the network operator device arranged in a communication network according to a state change in the communication device that communicates with the network operator device via the communication network managed by a communication provider.

A program according to a fourth exemplary aspect of the present invention causes a computer to execute a step of transmitting network assist information to a network operator device, the network assist information being used to change a network parameter associated with a communication device in the network operator device arranged in a communication network according to a state change in the communication device that communicates with the network operator device via the communication network managed by a communication provider.

### Advantageous Effects of Invention

According to the present invention, it is possible to provide a communication system, a communication device, a network parameter control method, and a program capable of executing optimization of network processing based on changes in utilization characteristics.

### BRIEF DESCRIPTION OF DRAWINGS

FIG. 1 is a configuration diagram of a mobile communication system according to a first exemplary embodiment;

FIG. 2 is a configuration diagram of a mobile communication system according to a second exemplary embodiment;

FIG. 3 is a diagram describing characteristic changes according to the second exemplary embodiment;

FIG. 4 is a configuration diagram of an M2M device according to the second exemplary embodiment;

FIG. 5 is a diagram for describing a database in which a content of an event and a content of the characteristic change are associated with each other according to the second exemplary embodiment;

FIG. 6 is a configuration diagram of a data transmission device according to the second exemplary embodiment;

FIG. 7 is a diagram for describing a database in which a content of the characteristic change and an NW parameter are associated with each other according to the second exemplary embodiment;

FIG. 8 is a sequence showing a flow of processing for changing the NW parameters according to the second exemplary embodiment;

FIG. 9 is a diagram for describing a change in a Paging Area according to the second exemplary embodiment;

FIG. 10 is a diagram for describing an operation in which an M2M device periodically transmits information acquired from a sensor to an application server according to a third exemplary embodiment;

FIG. 11 is a configuration diagram of an M2M device according to a fifth exemplary embodiment;

FIG. 12 is a diagram for describing an apparatus that constitutes a function of a data transmission device according to a sixth exemplary embodiment;

FIG. 13A is a sequence showing a flow of processing for changing NW parameters according to the sixth exemplary embodiment;

FIG. 13B is a sequence showing a flow of processing for changing the NW parameters according to the sixth exemplary embodiment;

FIG. 13C is a sequence showing a flow of processing for changing the NW parameters according to the sixth exemplary embodiment;

FIG. 14 is a diagram for showing network parameters held by an HSS according to the sixth exemplary embodiment;

FIG. 15 is a diagram for showing network parameters held by the HSS according to the sixth exemplary embodiment;

FIG. 16 is a diagram for showing network parameters held by an MME according to the sixth exemplary embodiment;

FIG. 17 is a diagram for showing network parameters held by the MME according to the sixth exemplary embodiment;

FIG. 18 is a diagram for showing network parameters held by the MME according to the sixth exemplary embodiment;

FIG. 19 is a diagram for showing network parameters held by an S-GW according to the sixth exemplary embodiment;

FIG. 20 is a diagram for showing network parameters held by a P-GW according to the sixth exemplary embodiment;

FIG. 21 is a diagram for showing network parameters held by the P-GW according to the sixth exemplary embodiment;

FIG. 22 is a diagram for showing network parameters held by a UE according to the sixth exemplary embodiment; and

FIG. 23 is a diagram for showing network parameters held by the UE according to the sixth exemplary embodiment.

### DESCRIPTION OF EMBODIMENTS

### First Exemplary Embodiment

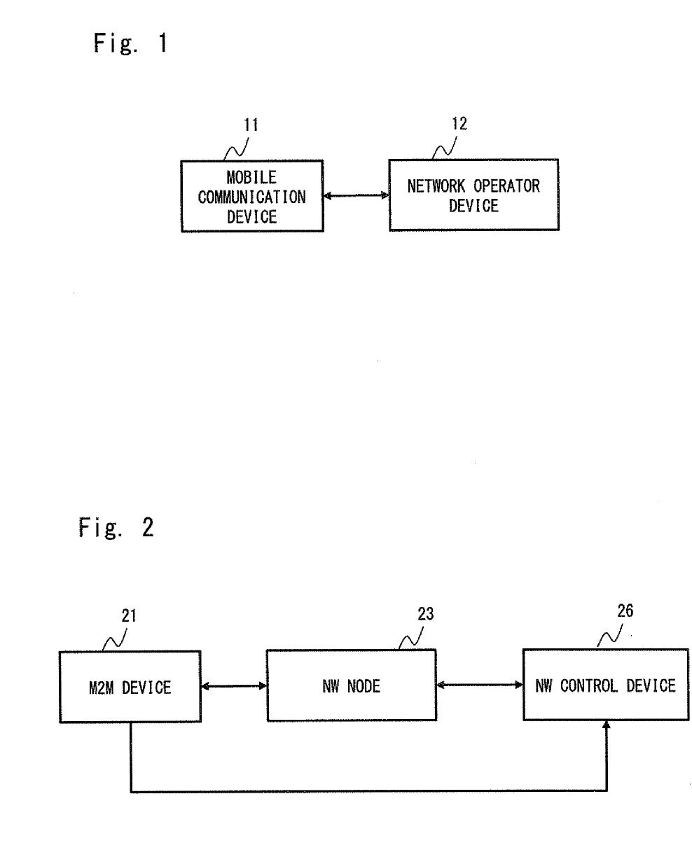

Hereinafter, with reference to the drawings, exemplary embodiments of the present invention will be described. With reference to FIG. 1, a configuration example of a mobile communication system according to a first exemplary embodiment of the present invention will be described. While the configuration example of the mobile communication system is described in FIG. 1, the present invention is not limited to being applied to the mobile communication system and may be applied to, for example, a fixed communication system. The mobile communication system in FIG. 1 includes a mobile communication device 11 and a network operator device 12.

The mobile communication device 11 may be a mobile telephone terminal, a smartphone terminal, a notebook personal computer or the like, moving means such as an automobile, a train or the like in which a communication function is installed, or a device such as a machine like a watch that is worn by a user in which a communication function is installed. The mobile communication device 11 may be a device that does not often move such as an automatic vending machine or an electrical appliance having a communication function.

The mobile communication device 11 detects a state change when, for example, there is a change in an operation state, a communication state, a moving state of the mobile communication device 11 or data held in the mobile communication device 11. Further, the mobile communication device 11 transmits to the network operator device 12 network assist information used to change network parameters associated with the mobile communication device 11 in association with information regarding the state change in the mobile communication device 11. More specifically, when the mobile communication device 11 is an automobile, the mobile communication device 11 may detect that the engine has been turned on or turned off. In this way, the information related to a movement of the mobile communication device 11 may be referred to as mobility information. In another example, when the mobile communication device 11 includes a sensor, the mobile communication device 11 may detect the state change in the mobile communication device 11 using the sensor. The information detected by the mobile communication device 11 using the sensor may be called connectivity information.

In another example, the mobile communication device 11 may detect a change in a battery capacity of the mobile communication device 11 as the state change. In another example, the mobile communication device 11 may detect information on an application installed in the mobile communication device 11 as the state change.

The network assist information is information used to adjust and optimize the network parameters managed by the network operator device 12. The network parameters are associated with the mobile communication device 11. Further, the network parameters are information and policies that allow each node device in the network to determine processing of the mobile communication device 11. The information and the policies to determine the processing of the mobile communication device 11 may be, for example, a telephone number, a QoS policy or the like. Each node device may be, for example, a base station, a core network device or the like in a mobile communication network. Next, the details of the network assist information will be described. The network assist information is, for example, information indicating moving characteristics and communication characteristics of the mobile communication device 11 or the state change in the mobile communication device 11. The network assist information further includes various types of information as information used to change the network parameters associated with the mobile communication device 11. The change in the moving characteristics may indicate that the state of the mobile communication device 11 has been changed from a state in which it moves to a state in which it is stopped. In another example, the change in the moving characteristics may indicate that the state of the mobile communication device 11 has been changed from a state in which it moves at a high speed to a state in which it moves at a low speed. The high speed may indicate, for example, the speed when a user of the mobile communication device 11 moves with a car or the like and the low speed may indicate, for example, the speed when the user of the mobile communication device 11 moves by foot. Otherwise, a threshold regarding the speed may be determined in advance, and it may be determined that the mobile communication device 11 moves at a high speed when the moving speed exceeds the threshold and may be determined that it moves at a low speed when the moving speed is below the threshold. In another example, the change in the moving characteristics may indicate that the state of the mobile communication device 11 has been changed from a state in which a frequency of the movement is high to a state in which a frequency of the movement is low. The frequency of the movement may be determined to be high when the number of times of movement exceeds a predetermined frequency and the frequency of the movement may be determined to be low when the number of times of movement is below the predetermined frequency. In another example, the change in the moving characteristics may indicate a change in a moving direction, a moving speed or the like. The information indicating the moving characteristics may be referred to as a mobility state.

The change in the communication characteristics may indicate that the amount of data transmitted from the mobile communication device 11 has been changed. In another example, the change in the communication characteristics may indicate that a communication band that the mobile communication device 11 requires has been changed. In another example, the change in the communication characteristics may indicate that the delay allowed by the mobile communication device 11 has been changed. In another example, the change in the communication characteristics may indicate that the intervals at which the mobile communication device 11 performs communication have been changed. The information indicating the communication characteristics may be referred to as a connectivity state.

Further, the network assist information may be information indicating a change in needs of a user of the mobile communication device 11. The information indicating the change in needs of the user of the mobile communication device 11 includes, for example, a change in a charging plan or a change in an IP address to be used.

The network assist information may further include information that indicates network processing.

The state change in the mobile communication device 11 in the network assist information may indicate, for example, a change in an amount of power consumption, a remaining amount of battery, or a charging state of the mobile communication device 11. In another example, the state change in the mobile communication device 11 may indicate, for example, an application that is currently running on the mobile communication device 11, end time of the application that is being activated, a predicted start time of the application or the like. In another example, the state change in the mobile communication device 11 may indicate, for example, a radio wave state or the like between the mobile communication device 11 and a base station or the like that performs radio communication with the mobile communication device 11.

The network operator device 12 is arranged in the mobile communication network managed by a mobile communication provider. Further, the network operator device 12 changes the network parameters associated with the mobile communication device 11 according to the network assist information regarding which a notification has been sent from the mobile communication device 11. The network parameters may be information on an area where the mobile communication device 11 is called when incoming call processing for the mobile communication device 11 is performed. In another example, the network parameters may be information on a timing for disconnecting the mobile communication device 11 from the mobile communication network.

As described above, with the use of the mobile communication system shown in FIG. 1, the network operator device 12 is able to acquire the network assist information from the mobile communication device 11. The network operator device 12 is therefore able to acquire the network assist information associated with various event notifications. The network operator device 12 is therefore able to set appropriate network parameters corresponding to various types of characteristic changes. It is therefore possible to achieve, for example, an efficient use of resources in the mobile communication network.

### Second Exemplary Embodiment

Next, with reference to FIG. 2, a configuration example of a mobile communication system according to a second exemplary embodiment of the present invention will be described. While a Machine to Machine (M2M) communication will be mainly described in the following description, the present invention is not limited to being applied to the M2M communication and may also be applied to general mobile communications or the like. The mobile communication system shown in FIG. 2 includes a Machine to Machine (M2M) device 21, an NW node 23, and an NW control device 26. The M2M device 21 corresponds to the mobile communication device 11. The NW node 23 and the NW control device 26 correspond to the network operator device 12. The NW node 23 and the NW control device 26 form a network. The network formed of the NW node 23 and the NW control device 26 may be a mobile communication network, a fixed communication network, a network used for a PLC or the like. The mobile communication network may be a network such as the 2G/3G/LTE defined by the 3GPP or may be a PHS network, a Wimax network, a wireless LAN or the like. In another example, the NW control device 26 may be a network (e.g., a node device in a core network) or may be a server device that is provided outside of the network and communicates with the NW node 23.

The M2M device 21 is, for example, a device that autonomously transmits data between communication devices without the intervention of a user's operation. When the M2M device 21 is an automobile, for example, the M2M device 21 detects a state in which the engine is turned on or off and autonomously notifies the NW control device 26 of the network assist information regarding the M2M device 21.

The NW node 23 receives user data or U-Plane data transmitted from the M2M device 21. The NW node 23 is arranged in the mobile communication network managed by the mobile communication provider. Further, the NW node 23 includes a plurality of node devices that execute NW processing. Each node device includes NW parameters to execute NW processing.

The NW node 23 manages the NW parameters that are necessary for the M2M device 21 to perform data communication via the NW node 23. The NW node 23 manages, for example, a Paging Area, which defines an area where the M2M device 21 is called when incoming call processing for the M2M device 21 is performed. Further, the NW node 23 manages a Tracking Area, which defines an area where the M2M device 21 performs location registration. Further, the NW node 23 manages a Tracking Area Update Timer, which is a period to register or update the area where the M2M device 21 is called (location registration period). Further, the NW node 23 manages an Inactivity Timer, an idle (dormant) Timer, or a Connection keep time, which defines a timing for changing the state of the M2M device 21 from a state in which it is connected to the NW node 23 (Connect Mode) to a state in which it is disconnected from the NW node 23 (Idle Mode). Further, the NW node 23 manages radio reception intervals or a DRX (discontinuous reception) timer, which defines a timing at which the M2M device 21 receives data. Further, the NW node 23 manages a Backoff Timer used to suppress congestion in the mobile communication network.

The adjustment of the Inactivity Timer is disclosed, for example, in 3GPP TR 23.887 V0.6.0 (2012-12) 3rd Generation Partnership Project; Technical Specification Group Services and System Aspects; Machine-Type and other Mobile Data Applications Communications Enhancements (Release 12).

The NW node 23 sets the network parameters changed based on the instruction from the NW control device 26. The NW node 23 may forward an instruction to change the network parameters transmitted from the NW control device 26 to another NW node 23. In this way, besides the case in which the NW node 23 directly receives the instruction to change the network parameters from the NW control device 26, the NW node 23 may receive the instruction to change the network parameters via the other NW node 23.

The NW control device 26 transmits a control message to the NW node 23. The NW control device 26 is arranged in the mobile communication network managed by the mobile communication provider. The NW control device 26 may receive information on the characteristic change in the M2M device 21 from the M2M device 21 and notify the NW node 23 of the network parameters to be changed.

Further, the information transmitted to the NW control device 26 from the M2M device 21 may include not only the network assist information but also an instruction to change or execute the processing on the network. The processing on the network may include, for example, changing the state of the terminal which is in the Connected state to the Idle mode. The processing on the network may also include, for example, detaching the M2M device 21 or changing the destination to which the M2M device 21 is connected from the base station to another base station.

When the network assist information transmitted from the M2M device 21 is not necessary, the NW control device 26 may discard the received network assist information. In another example, when the network assist information transmitted from the M2M device 21 is not necessary, the NW control device 26 may notify the M2M device 21 of necessary network assist information to acquire the necessary network assist information. In another example, the NW control device 26 may send an instruction to change the network parameters using a part of the network assist information transmitted from the M2M device 21. In another example, the NW control device 26 may analyze or observe the network assist information transmitted from the M2M device 21 to generate necessary information.

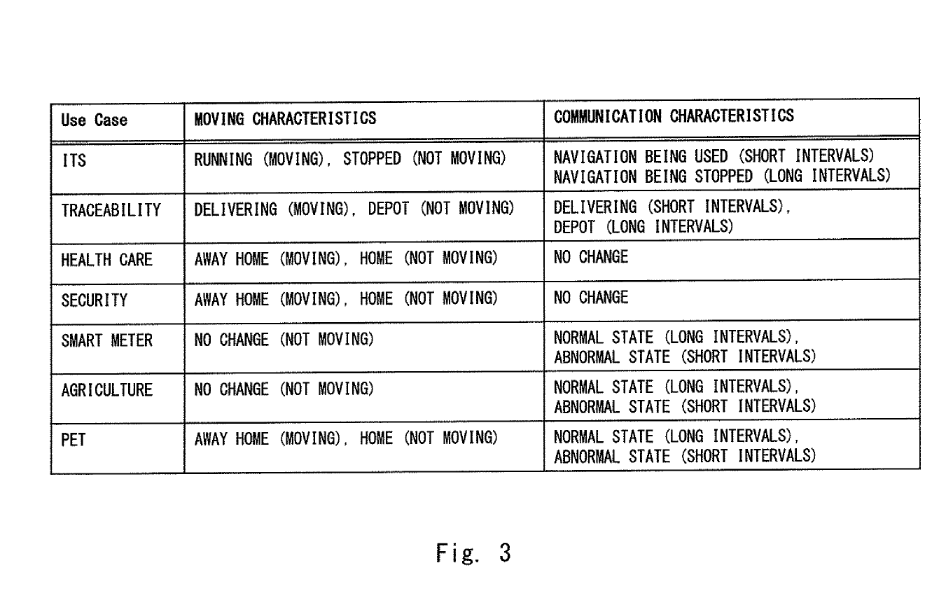

With reference to FIG. 3, examples of the specific network assist information according to the second exemplary embodiment of the present invention will be described. In an Intelligent Transport System (ITS), for example, upon detecting the state change indicating that the engine of the automobile is turned on and the automobile is running, the M2M device 21 determines that the automobile is moving and detects the moving characteristic change indicating that the automobile is in the moving state. Further, upon detecting the state change indicating that the engine of the automobile is turned off and the automobile is stopped, the M2M device 21 determines that the automobile is not moving and detects the moving characteristic change indicating that the automobile is in the stopped state. Further, upon detecting the state change indicating that a navigation system of the automobile is started and the navigation system is being used, the M2M device 21 detects the communication characteristic change indicating that the communication intervals are short. Further, upon detecting the state change indicating that the navigation system of the automobile is stopped and the navigation system is not used, the M2M device 21 detects the communication characteristic change indicating that the communication intervals are long.

In a traceability that tracks distribution channels of items, upon detecting the state change indicating that the engine of the automobile is turned on and the automobile is making a delivery, the M2M device 21 determines that the automobile is in the moving state and detects the moving characteristic change indicating that the automobile is moving. Further, upon detecting the state change indicating that the engine of the automobile is turned off and stopped at a depot, the M2M device 21 determines that the automobile is in the stopped state and detects the moving characteristic change indicating that the automobile is not moving. Further, upon detecting the state change indicating that the automobile is making a delivery, the M2M device 21 detects the communication characteristic change that the communication intervals are short. Further, upon detecting the state change indicating that the automobile is stopped at a depot, the M2M device 21 detects the communication characteristic change that the communication intervals are long.

Upon detecting the state change indicating that a terminal, a device or the like regarding a health care or a security is not located at home, the M2M device 21 detects the moving characteristic change indicating that the terminal, the device or the like is in the moving state. Further, upon detecting the state change indicating that the terminal, the device or the like regarding the health care or the security is located at home, the M2M device 21 detects the moving characteristic change indicating that the terminal, the device or the like is not moving. The M2M device 21 may use GPS data as the location information.

Upon detecting the state change indicating that a power value monitored using a smart meter is an abnormal value, the M2M device 21 detects the communication characteristic change indicating that the communication intervals of the smart meter are short since the power value is frequently sent. Further, upon detecting the state change indicating that a power value monitored using a smart meter is a normal value, the M2M device 21 detects the communication characteristic change indicating that the communication intervals of the smart meter are long since the power value is sent at predetermined time intervals. A change in the communication characteristics of a temperature value or the like measured by a monitoring device or the like used in the field of agriculture may be detected in a similar way as in the smart meter.

When a communication device is attached to a pet which is to be monitored, upon detecting the state change indicating that the pet is not at home, the M2M device 21 detects the moving characteristic change indicating that the pet is in the moving state. Further, upon detecting the state change indicating that the pet is at home, the M2M device 21 detects the moving characteristic change indicating that the pet is not moving. Further, when a communication device including a sensor function that detects the heart rate, the body temperature or the like is attached to the pet whose health condition is to be monitored, upon detecting the state change indicating that a value detected by the sensor is an abnormal value, the M2M device 21 detects the communication characteristic change indicating that the communication intervals are short since the state of the pet needs to be frequently monitored. Further, upon detecting the state change indicating that the value detected by the sensor is a normal value, the M2M device 21 detects the communication characteristic change indicating that the communication intervals are long since it is sufficient to monitor the state of the pet at predetermined time intervals.

Now, examples of the network assist information detected in the M2M device 21 other than the moving characteristics and the communication characteristics shown in FIG. 3 will be described. The M2M device 21 detects, for example, the change in the battery capacity. The M2M device 21 may periodically acquire the state regarding the battery capacity of the M2M device 21. The information regarding the battery capacity includes an amount of battery consumption, a remaining amount of battery, a charging state and the like. By periodically acquiring information regarding the battery state, the M2M device 21 is able to estimate the transition of the remaining amount of battery or the amount of power consumed in a predetermined period. Therefore, the M2M device 21 may detect whether the amount of power consumption is large or small from the amount of power consumption estimated in the predetermined period. Further, the M2M device 21 may estimate the time until when the battery capacity is depleted using the amount of power consumption estimated in the predetermined period. The amount of power consumption may be determined to be large when the amount of power consumption exceeds a predetermined threshold and the amount of power consumption may be determined to be small when the amount of power consumption is below the predetermined threshold.

Further, examples of the network assist information detected in the M2M device 21 will be described. For example, the M2M device 21 may acquire application information installed in the M2M device 21. The application information includes an application that is currently running, end time of the application that is currently running, a predicted start time of an application and the like. The M2M device 21 may detect information regarding the communication band that is necessary in the application that is currently running, information regarding intervals at which the application is started or the like.

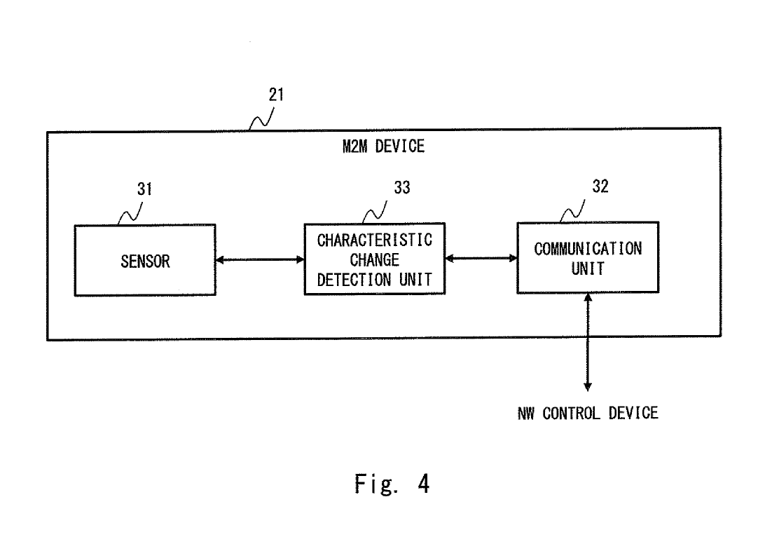

Next, with reference to FIG. 4, a configuration example of the M2M device 21 according to the second exemplary embodiment of the present invention will be described. The M2M device 21 includes a sensor 31, a communication unit 32, and a characteristic change detection unit 33. The functions of the sensor 31 when, for example, the M2M device 21 is a car such as a general vehicle, a truck, a taxi or the like will be described. In this case, the sensor 31 detects ON/OFF information on the engine and ON/OFF information on the navigation system. The sensor 31 may further collect GPS data. The sensor 31 outputs the information that is detected or collected to the characteristic change detection unit 33.

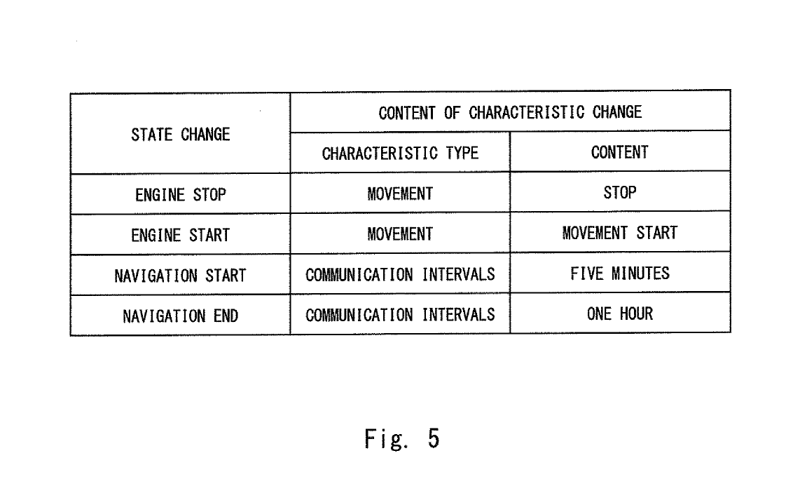

Upon receiving the information regarding the state change from the sensor 31, the characteristic change detection unit 33 detects the characteristic change corresponding to the state change that has been received. For example, the characteristic change detection unit 33 may detect the characteristic change using a database shown in FIG. 5 in which the content of the event and the content of characteristic change are associated with each other. In the following description, a configuration example of the database shown in FIG. 5 will be described.

The database shown in FIG. 5 manages the information regarding the state change regarding which a notification is sent and the information regarding the content of the characteristic change in association with each other. Further, the content of the characteristic change can be classified into a characteristic type and a characteristic content corresponding to the characteristic type. The state change includes, for example, an engine stop, an engine start, a navigation start, a navigation stop and the like. The state change of the engine stop is associated with the content of the characteristic change in which the characteristic type is “movement” and the characteristic content is “stop”. Upon receiving the state change indicating that the engine has been stopped, the M2M device 21 detects that the movement of the M2M device 21 has been stopped. Upon receiving the state change indicating that the engine has been started, the M2M device 21 detects that the M2M device 21 has started the movement. The state in which the movement has been stopped may be referred to as a Low Mobility state or a No mobility state. Further, the state in which the movement has been started may be referred to as a High Mobility state.

Further, upon receiving the state change indicating that the navigation has been started, the M2M device 21 detects that the communication intervals such as intervals at which the information is distributed to the navigation are five minutes. Upon receiving the state change indicating that the navigation has been ended, the M2M device 21 detects that the communication intervals such as intervals at which the information is distributed to the navigation are one hour. The time regarding the information distribution intervals here is merely one example and may be changed.

The characteristic change detection unit 33 outputs information on the characteristic change that has been detected to the communication unit 32. The communication unit 32 communicates with the NW control device 26. The communication unit 32 transmits the information on the characteristic change output from the characteristic change detection unit 33 to the NW control device 26.

The communication unit 32 transmits the information output from the characteristic change detection unit 33 to the NW control device 26 as the network assist information. The communication unit 32 transmits the network assist information as a control signal via a radio link provided by the mobile communication provider.

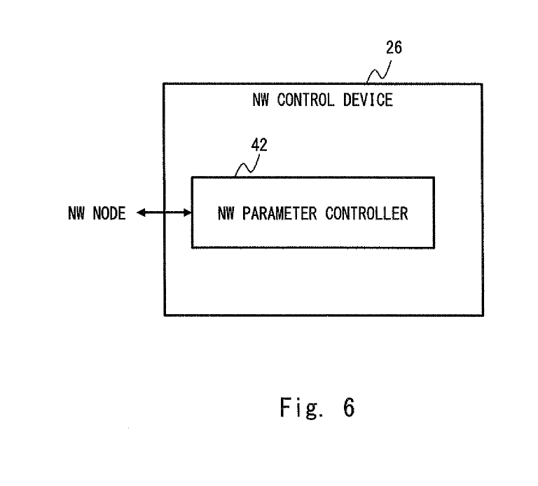

Next, with reference to FIG. 6, a configuration example of the NW control device 26 according to the second exemplary embodiment of the present invention will be described. The NW control device 26 includes a NW parameter controller 42.

The NW parameter controller 42 instructs the NW node 23 involved in the changes in the NW parameters to change the NW parameters regarding the M2M device 21 based on the network assist information transmitted from the M2M device 21.

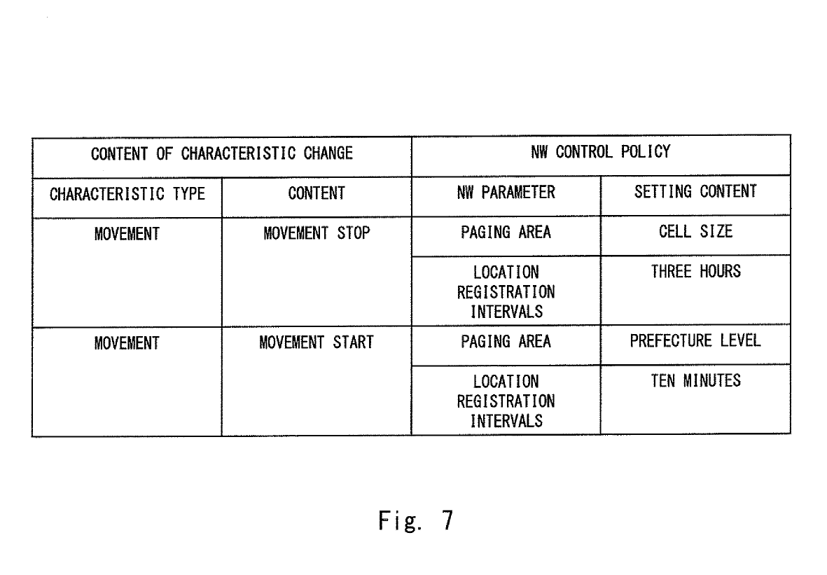

The NW parameter controller 42 may specify the NW parameters using a database shown in FIG. 7 in which the content of characteristic change (network assist information) and the NW parameter are associated with each other. In the following description, a configuration example of the database shown in FIG. 7 will be described.

The database shown in FIG. 7 manages the information on the content of the characteristic change and the information on the NW control policy in association with each other. The information on the content of the characteristic change is similar to the content of the characteristic change in the database shown in FIG. 5. The information on the NW control policy is classified into the NW parameters and the content of the setting.

Upon receiving the network assist information indicating “movement” as the characteristic type and “movement stop” as the content of the characteristic change from the M2M device 21, for example, the NW parameter controller 42 may determine the NW control policy to set the size of the paging area regarding the M2M device 21 to a cell size managed by one base station and determine the location registration intervals (Tracking Area Update Timer) of the M2M device 21 as every three hours. Further, upon receiving the network assist information indicating “movement” as the characteristic type and “movement start” as the content of the characteristic change from the M2M device 21, the NW parameter controller 42 may determine the NW control policy to set the size of the paging area regarding the M2M device 21 to the size by prefectures and determine the location registration intervals of the M2M device 21 as every ten minutes.

That is, when the M2M device 21 stops moving, the moving range becomes small, which means it is possible to narrow down the paging area as well. It is therefore possible to set only the cell area formed of one base station to a paging area. Meanwhile, when the M2M device 21 starts moving, the moving range becomes large. Therefore, the paging area needs to be increased in order to definitely call for the M2M device 21. Therefore, for example, all the cell areas formed of the base stations in the same prefecture may be set to a paging area. Further, when the M2M device 21 stops moving, the location registration intervals may be set longer since the M2M device 21 is highly likely to be in one location registration area. On the other hand, when the M2M device 21 starts moving, the location registration intervals may be set shorter since the M2M device 21 is highly likely to be in different location registration areas as time proceeds.

The content of the setting of the NW parameters when a content of the characteristic change different from the content of the characteristic change shown in FIG. 7 is detected will be described. Upon receiving the network assist information indicating that the amount of power consumption of the M2M device 21 is large from the M2M device 21, for example, the NW parameter controller 42 may perform control to increase the intervals at which the M2M device 21 performs radio communication. The information regarding the intervals at which the M2M device 21 performs radio communication may be referred to as a DRX timer and the NW parameter controller 42 may control the DRX timer. The M2M device 21 is able to operate the communication function only at a timing at which the radio communication is performed and to stop the communication function at other timings. In such a case, by increasing the intervals at which the M2M device 21 performs communication, the power consumption can be suppressed, whereby it is possible to increase the time during which the M2M device 21 is used.

Further, the NW parameter controller 42 may control the DRX timer by combining the information regarding the amount of power consumption and the information regarding the moving characteristics. For example, even when the network assist information indicating that the amount of power consumption is large is notified, the NW parameter controller 42 may determine that the M2M device will be charged within a predetermined period of time if the M2M device 21 is moving toward home. In such a case, the NW parameter controller 42 may perform control so as to decrease the intervals at which the M2M device 21 performs communication.

Further, upon receiving the network assist information from the M2M device 21 indicating that the application activated in the M2M device 21 requires a wide communication band or a high-speed communication, for example, the NW parameter controller 42 may allocate to the M2M device 21 more communication resources than usual. The communication resources include, for example, a communication band, a communication channel or the like. Further, the NW parameter controller 42 may control the allocation of the communication resources based on the information regarding the application which will be started in the M2M device 21.

Further, upon receiving a notification of a bandwidth required in the M2M device 21 from the M2M device 21, the NW parameter controller 42 may determine the bearer that is to be used by the M2M device 21. The bearer may be, for example, a radio bearer used in the 2G/3G network of the 3GPP, a radio bearer used in the LTE of the 3GPP, a radio bearer used in the wireless LAN, a radio bearer used in the PHS, or a radio bearer used in the Wimax. Further, the NW parameter controller 42 may cause the M2M device 21 to connect to a fixed communication network or a network used in a power-line carrier communication (PLC). Further, upon receiving a notification of a bandwidth required in the M2M device 21 from the M2M device 21, the NW parameter controller 42 may change the transmission power for the M2M device 21 in the base station that accommodates the M2M device 21.

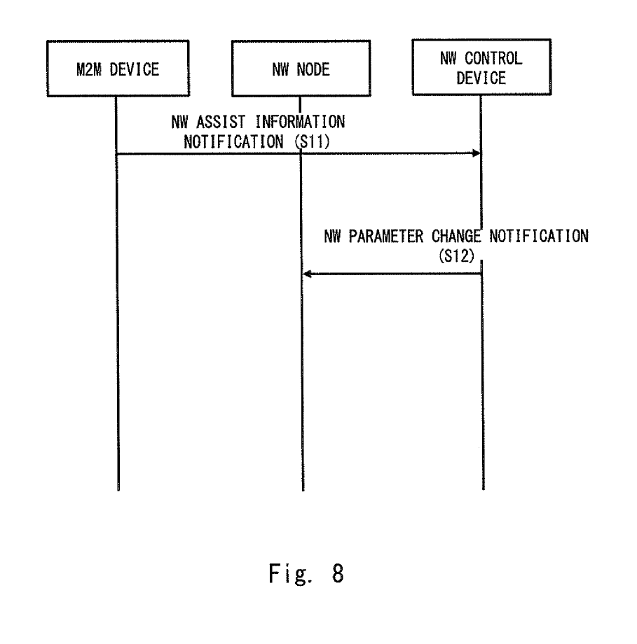

Next, with reference to FIG. 8, a flow of processing for changing the NW parameters according to the second exemplary embodiment of the present invention will be described. First, the M2M device 21 transmits the network assist information to the NW control device 26 (S11). The M2M device 21 detects a state change in the M2M device 21 when the M2M device 21 transmits the network assist information. The information regarding the state change detected by the M2M device 21 may be referred to as mobility information. For example, the M2M device 21 detects information indicating that the engine is turned on or off as the mobility information. In another case, the network assist information transmitted from the M2M device 21 may be referred to as a mobility state. For example, upon detection of information regarding the state change indicating that the engine is turned on, the M2M device 21 sets “moving”, High Mobility, or the normal state as the moving characteristics and transmits the network assist information. In another case, upon detection of information regarding the state change indicating that the engine is turned off, the M2M device 21 sets Low Mobility or No Mobility as the moving characteristics and transmits the network assist information.

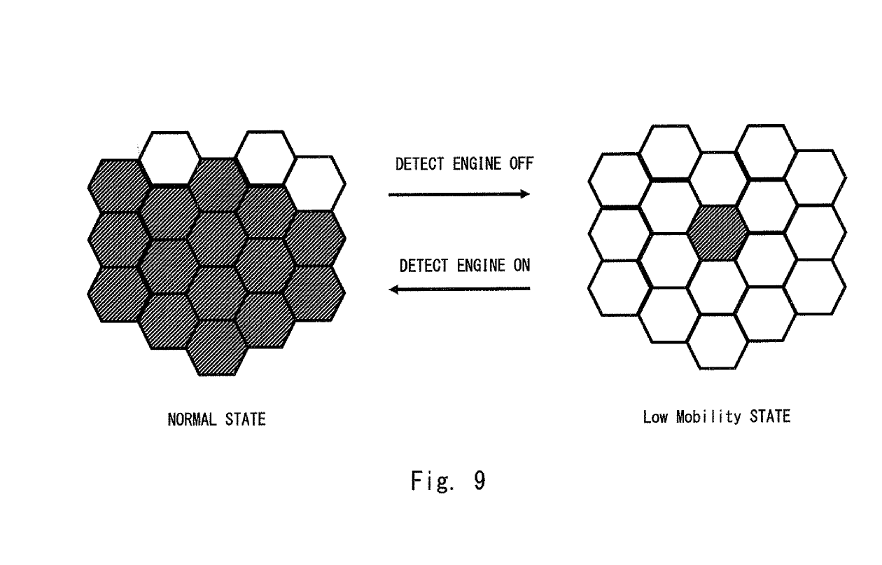

Next, the NW control device 26 transmits an NW parameter change notification message to the NW node 23 based on the network assist information transmitted from the M2M device 21 (S12). The NW parameters to be changed will be described with reference to FIG. 9. In FIG. 9, the NW parameters will be described using the Paging Area. Upon receiving a notification indicating that the M2M device 21 is in the Low Mobility state or the No Mobility state from the M2M device 21, the NW control device 26 notifies the NW node 23 that the Paging Area is set to the cell to which the M2M device 21 has last connected (shaded part in the Low Mobility state in FIG. 9). Further, upon receiving a notification indicating that the M2M device 21 is in the normal state or the High Mobility state from the M2M device 21, the NW control device 26 notifies the NW node 23 that the Paging Area is set to the cells registered in a Tracking Area List (shaded part in the normal state in FIG. 9). The Tracking Area List is a list including a plurality of cells that are determined in advance as cells that calls for the M2M device 21. As will be shown from FIG. 9, the Paging Area in the normal state and the like is wider than that in the Low Mobility state and the like.

As described above, with the use of the mobile communication system according to the second exemplary embodiment of the present invention, it is possible to set appropriate NW parameters applied to the NW node 23 based on the network assist information regarding which a notification has been sent from the M2M device 21 also in the system to provide the M2M service.

### Third Exemplary Embodiment

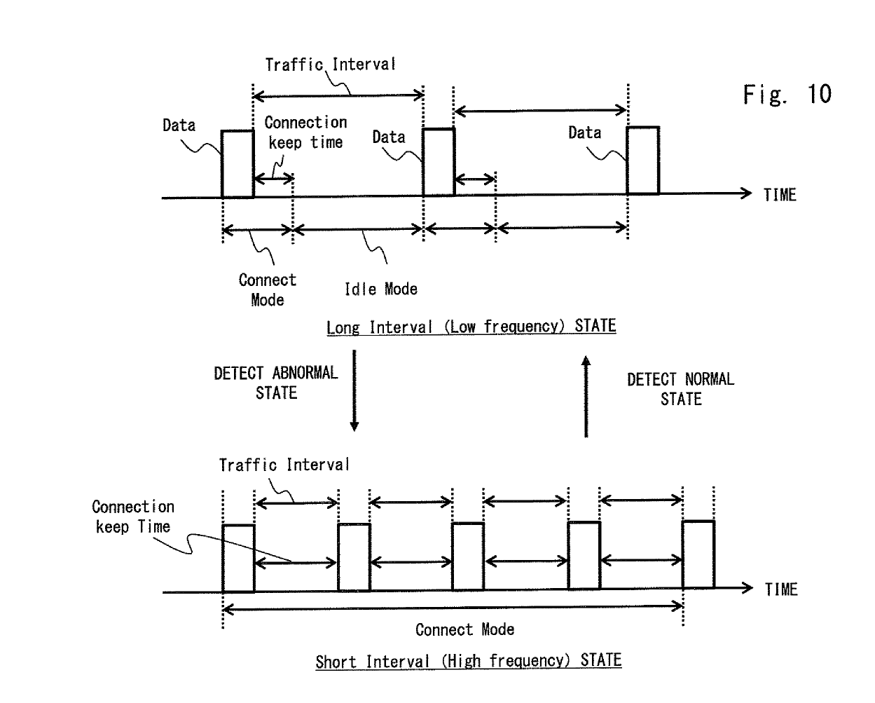

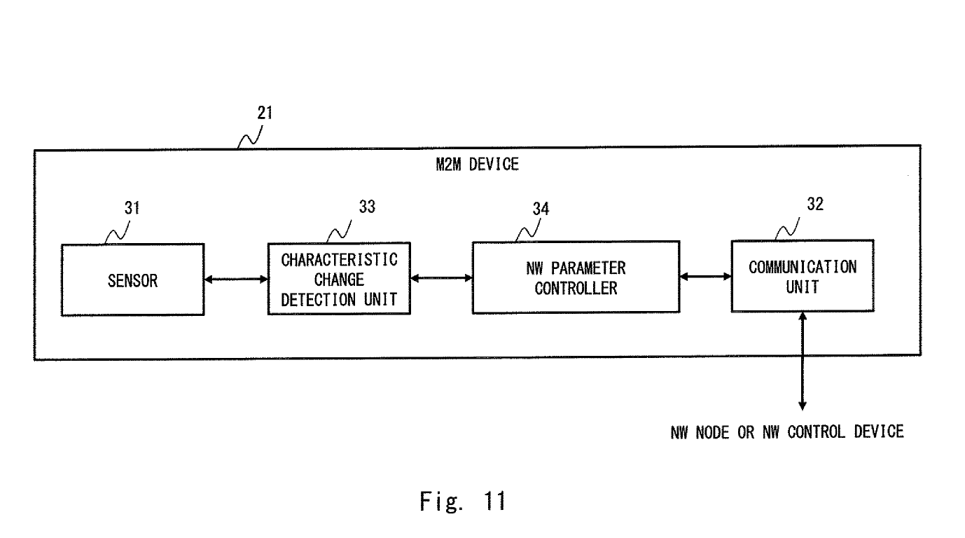

Next, with reference to FIG. 10, a flow of processing for changing NW parameters when the M2M device 21 periodically transmits information acquired from a sensor to the NW control device 26 will be described.

FIG. 10 shows intervals at which the M2M device 21 transmits data. The Traffic Interval indicating the intervals at which the data is transmitted in the Low frequency state or the Long Interval state is longer than the Traffic Interval in the High frequency state or the Short Interval state. Further, in the Long Interval state, after the data transmission is started, the M2M device 21 is connected to the NW node 23 for a predetermined period of time. This period is called a Connect Mode. Further, a state in which the M2M device 21 is not connected to the NW node 23 is called an Idle Mode. Further, a period from the time at which the data transmission is completed until the time at which the M2M device 21 switches from the Connect Mode to the Idle Mode is referred to as an Inactivity Timer or a Connection keep time. Hereinafter, a flow of processing for changing the NW parameters will be described with reference to FIG. 8. Before describing FIG. 8, FIG. 10 will be described as appropriate.

First, the M2M device 21 detects whether the information acquired using the sensor is in the normal state or the abnormal state. The M2M device 21 may include a sensor related to the agriculture (e.g., a temperature sensor), a smart grid, or a sensor to monitor pets, for example. The abnormal state is a state in which the value of radioactivity, temperature, vibration or the like acquired using the sensor exceeds a reference value, for example. The normal state is a state in which the value of radioactivity, temperature, vibration or the like acquired using the sensor does not exceed the reference value, for example.

Next, upon detection of the normal state, the M2M device 21 sets the Long Interval state as the communication characteristics and transmits the network assist information to the NW control device 26 (S11). Further, upon detection of the abnormal state, the M2M service PF 27 sets the Short Interval state as the communication characteristics and transmits the network assist information to the NW control device 26 (S11).

Next, when the Long Interval state is set as the network assist information, the NW control device 26 notifies the NW node 23 that the Short connect mode is set for the Connection keep time in order to decrease the period of the state in which the M2M device 21 is connected to the NW node 23 (S12). When the Short Interval state is set as the network assist information, the NW control device 26 notifies the NW node 23 that the Long connect mode is set for the Connection keep time in order to increase the period of the state in which the M2M device 21 is connected to the NW node 23 (S12). The Connection keep time for which the Long connect mode is set is longer than the Connection keep time for which the Short connected mode is set.

As described above, the Connection keep time is changed according to whether the information acquired using the sensor of the M2M device 21 indicates the normal state or the abnormal state, whereby it is possible to increase the time during which the Idle Mode is set to reduce the power consumption in the M2M device 21 in the Long Interval state. Since the Traffic Interval is short in the Short Interval state, the M2M device 21 is able to reduce the number of times of switching between the Connect Mode and the Idle Mode, whereby it is possible to simplify the control operation by decreasing the time during which the Idle Mode is set.

### Fourth Exemplary Embodiment

Next, another example of the NW assist information regarding which a notification is sent to the NW control device 26 from the M2M device 21 will be described. The M2M device 21 regularly collects, for example, information on changes in the amount of data communication in the M2M device 21, changes in the communication intervals or the like. In this case, the M2M device 21 may calculate, for example, the average value, the maximum value, the minimum value or the like of the amount of data communication in a predetermined period. Further, the M2M device 21 may calculate a variance of the amount of data communication and also calculate the expected value or the like of the amount of data communication based on the calculated variance. The M2M device 21 may notify the NW control device 26 of the statistical information thus calculated as the network assist information.

The NW control device 26 may change, for example, the communication resources to be allocated to the M2M device 21 using the network assist information on the amount of data communication regarding which a notification has been sent from the M2M device 21. Besides the statistical information regarding the amount of data communication, the M2M device 21 may calculate statistical information regarding moving characteristics, battery information, application information, a radio wave state or the like.

### Fifth Exemplary Embodiment

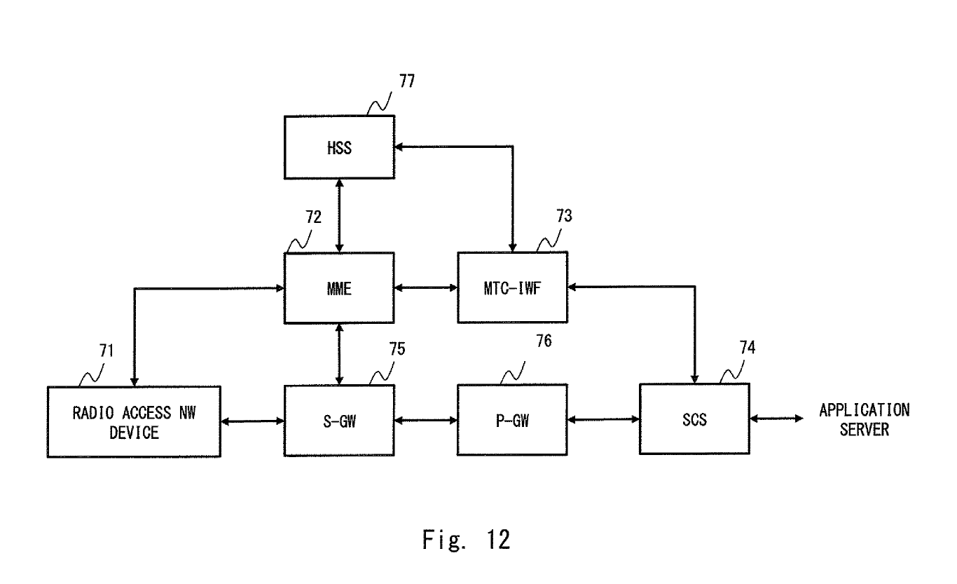

Next, with reference to FIG. 11, a configuration example of the M2M device 21 according to a fifth exemplary embodiment of the present invention will be described. The M2M device 21 shown in FIG. 11 is different from the M2M device 21 shown in FIG. 4 in that an NW parameter controller 34 is included in the M2M device 21 shown in FIG. 11. The NW parameter controller 34 determines network parameters to be changed based on the information regarding the characteristic change output from the characteristic change detection unit 33. Since the process operation of the NW parameter controller 34 is similar to that of the NW parameter controller 42 of the NW control device 26 in FIG. 6, the detailed description will be omitted.

Upon receiving an instruction to change the NW parameters from the NW parameter controller 34, the communication unit 32 instructs the NW node 23 or the NW control device 26 involved in the change in the NW parameters to change the NW parameters. Upon receiving a message to indicate the change in the NW parameters transmitted from the M2M device 21, the NW node 23 and the NW control device 26 determine whether to allow the change in the NW parameters. Upon determination that the change in the NW parameters is allowed, the NW node 23 and the NW control device 26 change the NW parameters in the NW node 23.

As described above, by determining the NW parameters that should be changed by the M2M device 21, the processing load in the NW control device 26 is reduced.

### Sixth Exemplary Embodiment

Next, with reference to FIG. 12, a configuration example of a network according to a sixth exemplary embodiment of the present invention will be described. In FIG. 12, an example in which the mobile communication provider uses a mobile communication network defined by the 3rd Generation Partnership Project (3GPP) will be described. In FIG. 12, a radio access NW device 71, an HSS 77, a Mobility Management Entity (MME) 72, a Serving Gateway (S-GW) 75, and a Packet Data Network Gateway (P-GW) 76 correspond to the NW node 23. Further, the NW node 23 may include a PCRF, which is a node device defined by the 3GPP.

Further, an MTC-IWF 73 corresponds to the NW control device 26. An SCS 74 corresponds to the M2M service plat PF. In another example, the SCS 74 may correspond to the NW control device.

The radio access NW device 71 may be a base station. Further, the radio access NW device 71 may be an eNB which is a base station when the Long Term Evolution (LTE) is used as a wireless system. The MME 72 mainly performs mobility management of the M2M device 21. The SCS 74 is a communication node provided to communicate with the application server and acquires information on the event notification from the application server. The SCS 74 outputs information on the characteristic change generated based on the event notification to the MTC-IWF 73. A Tsp interface defined in the 3GPP is used as an interface between the MTC-IWF 73 and the SCS 74. A Diameter protocol is used as the Tsp interface.

The S-GW 75 and the P-GW 76 transmit or receive user data such as image data or voice data transmitted from the M2M device 21. The S-GW 75 and the P-GW 76 receive the user data transmitted via the radio access NW device 71 and output it to the SCS 74.

The MTC-IWF 73 changes the NW parameters regarding the M2M device 21 managed by the HSS 77, the MME 72, the S-GW 75, the P-GW 76 and the like based on the information on the transformation of characteristics output from the SCS 74. Further, when the MME 72 and the HSS 77 manage the NW parameters regarding the M2M device 21, the MTC-IWF 73 changes the NW parameters regarding the M2M device 21 managed in the MME 72 and the HSS 77. In another example, in order to change the NW parameters regarding the M2M device 21 managed by the eNB, which is the S-GW 75, the P-GW 76, or the radio access NW device 71 based on the information regarding the transformation of characteristics output from the SCS 74, the MTC-IWF 73 may change the NW parameter of each device via the MME 72. Hereinafter, a case in which the Paging Area (or Tracking Area), the Tracking Area Update Timer, the Inactivity Timer, the Connection keep time, the DRX Timer, the Backoff Timer, the communication policy, the QCI (QoS), the bandwidth guarantee parameters and the like are used as the NW parameters will be described in detail.

The MTC-IWF 73 outputs a change instruction message to the HSS 77 or the MME 72 to change the Paging Area (or the Tracking Area), for example. Further, the MTC-IWF 73 outputs a change instruction message to the HSS 77 to change the Tracking Area Update Timer. When the MME 72 manages the Tracking Area Update Timer, the MTC-IWF 73 may output the change instruction message regarding the Tracking Area Update Timer to the MME 72 as well.

The MTC-IWF 73 outputs the change instruction message to the HSS 77 or the MME 72 to change the Inactivity Timer, the Connection keep time, or the DRX Timer. Further, the MTC-IWF 73 outputs the change instruction message to the eNB in order to change the parameters associated with the Inactivity Timer or the like held by the eNB.

The MTC-IWF 73 outputs the change instruction message to the MME 72 to change the Backoff Timer. The MTC-IWF 73 outputs a change instruction message to the PCRF 78, the S-GW 75, and the P-GW 76 to change the communication policy, the QCI (QoS), the bandwidth guarantee parameters and the like. Further, the MTC-IWF 73 is able to appropriately change the destination to which the change instruction message is output when, for example, a device that manages the NW parameters is changed or newly provided.

As described above, with the use of the mobile communication system according to the fifth exemplary embodiment of the present invention, the NW parameters managed in the HSS 75 or the MME 72 can be changed to appropriate values also in a case in which the network defined by the 3GPP is used based on the information regarding the characteristic change in the M2M device 21 sent from the M2M service PF 27.

While the network shown in FIG. 12 has been described using a configuration example of an Evolved Packet Core (EPC) used in the LTE, the network in the UMTS may be configured using a concept similar to that in the LTE. In the case of the UMTS, for example, the operation of the MME 72 shown in FIG. 12 may be performed by a control plane of a Serving GPRS Support Node (SGSN). The operation of the HSS 77 may be performed by a Home Location Register (HLR). The operation of the S-GW 75 may be performed by a user plane function of the SGSN. The operation of the P-GW 76 may be performed by a Gateway GPRS Support Node (GGSN). Further, the operation of the radio access NW device 71 may be performed by a Radio Network Controller (RNC).

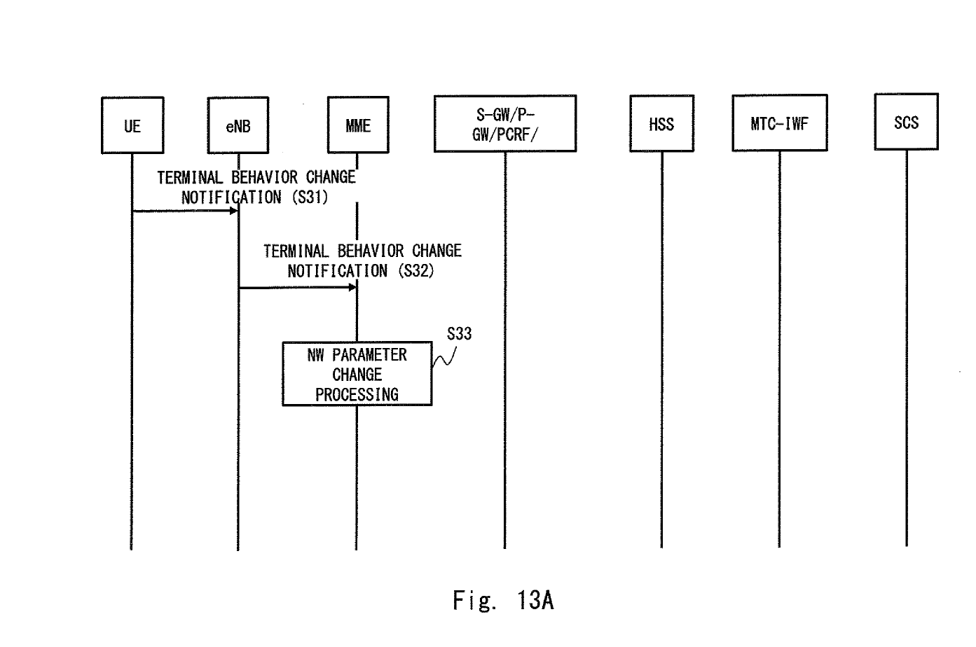

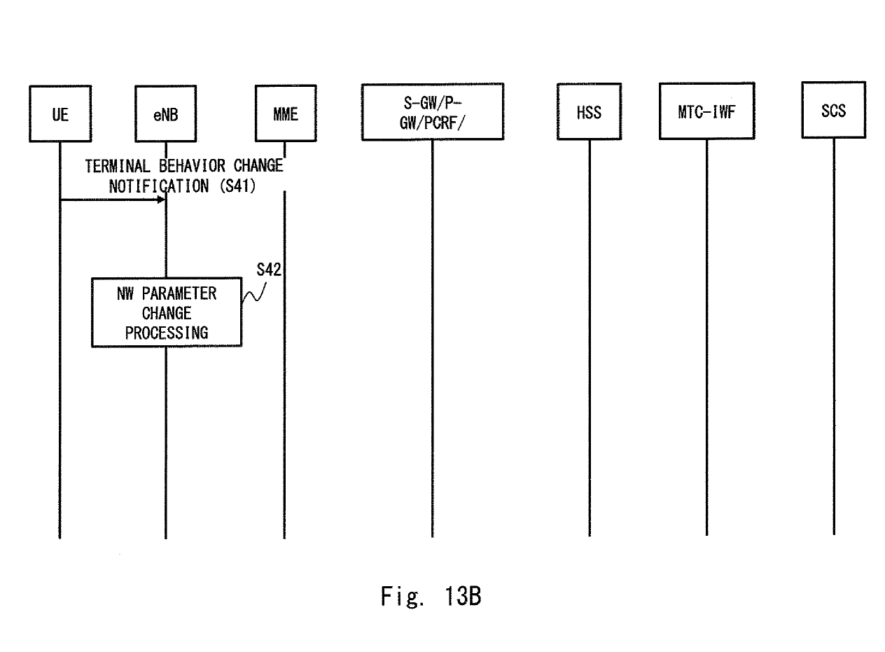

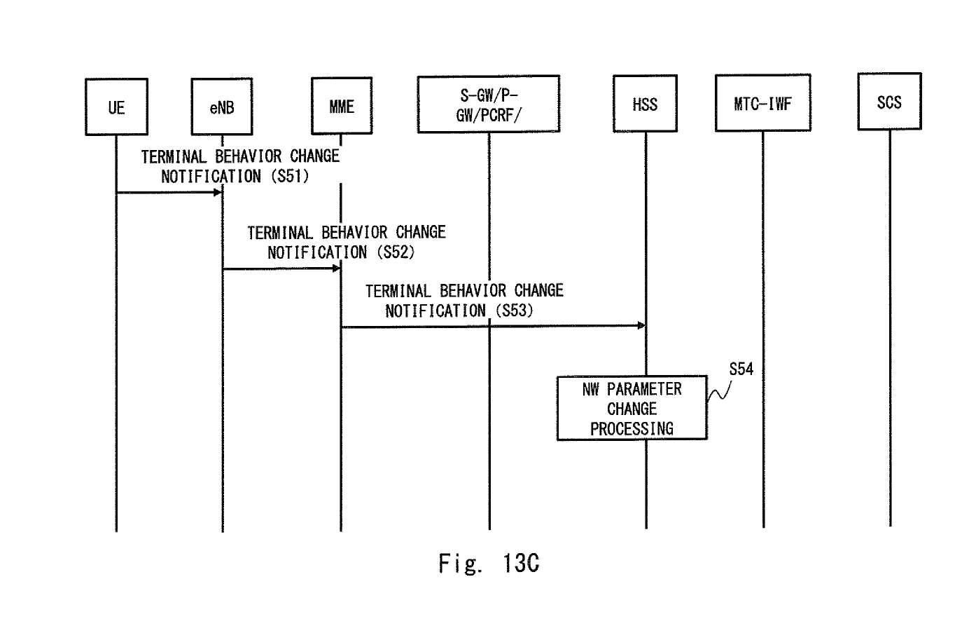

Next, with reference to FIGS. 13A to 13C, a flow of processing of a case in which the network assist information generated based on the state change in the mobile communication device 11 detected by the mobile communication device 11 is transmitted to the network operator device 12 will be described. In FIG. 13, a User Equipment (UE) is used as a specific example of the mobile communication device 11 and an eNB, an MME, an S-GW, a P-GW, a PCRF, an HSS, an MTC-IWF, and an SCS are used as specific examples of the network operator device 12.

In FIG. 13A, an example of changing the network parameters in the MME will be described. First, the UE transmits a terminal behavior change notification message to the eNB (S31). The terminal behavior change notification message includes the network assist information and a terminal identifier of the UE. In Step S31 in FIG. 13A, the mobile communication device 11 transmits the terminal behavior change notification message including the network assist information as the control message or the control data different from the user data.

Next, the eNB transmits the terminal behavior change notification message to the MME (S32). The MME changes the NW parameters regarding the UE according to the network assist information on the UE that has been sent (S33). The MME may transmit, when it is determined that the NW parameters need to be changed in another network operator device according to the network assist information of the UE that has been sent, the terminal behavior change notification message to another network operator device.

Next, with reference to FIG. 13B, an example of changing the network parameters in the eNB will be described. The case in which the network parameters are changed in the eNB includes, for example, a case in which the Inactivity Timer or the like held by the eNB is changed. First, the UE transmits the terminal behavior change notification message to the eNB (S41). The terminal behavior change notification message includes the network assist information and a terminal identifier of the UE. In Step S31 in FIG. 13B, the mobile communication device 11 transmits the terminal behavior change notification message including the network assist information as the control message or the control data different from the user data.

The eNB changes the NW parameters regarding the UE according to the network assist information on the UE that has been sent (S42).

Next, with reference to FIG. 13C, an example of changing the network parameters in the HSS will be described. The case in which the network parameters are changed in the HSS includes, for example, a case in which a QoS policy, a charging policy or the like is changed. First, the UE transmits the terminal behavior change notification message to the eNB (S51). The terminal behavior change notification message includes the network assist information and a terminal identifier of the UE. In Step S51 in FIG. 13C, the mobile communication device 11 transmits the terminal behavior change notification message including the network assist information as the control message or the control data different from the user data.

Next, the eNB transmits the terminal behavior change notification message to the MME (S52). Next, the MME transmits the terminal behavior change notification message to the HSS (S53). The HSS changes the NW parameters regarding the UE according to the network assist information of the UE that has been notified (S54).

Further, the UE may transmit the terminal behavior change notification message to the SCS using an OMA-DM protocol. Upon receiving the terminal behavior change notification message, the SCS transmits the terminal behavior change notification message to the MTC-IWF and the MTC-IWF changes the NW parameters.

While the example in which the UE transmits the network assist information to the eNB using the control message has been described in the above example, the UE may transmit information regarding the state change in the UE to the eNB using the control message. In such a case, the eNB, the MME or the like that has received the information on the state change from the UE may determine the network parameters to be changed based on the information regarding the state change in the UE that has been received.

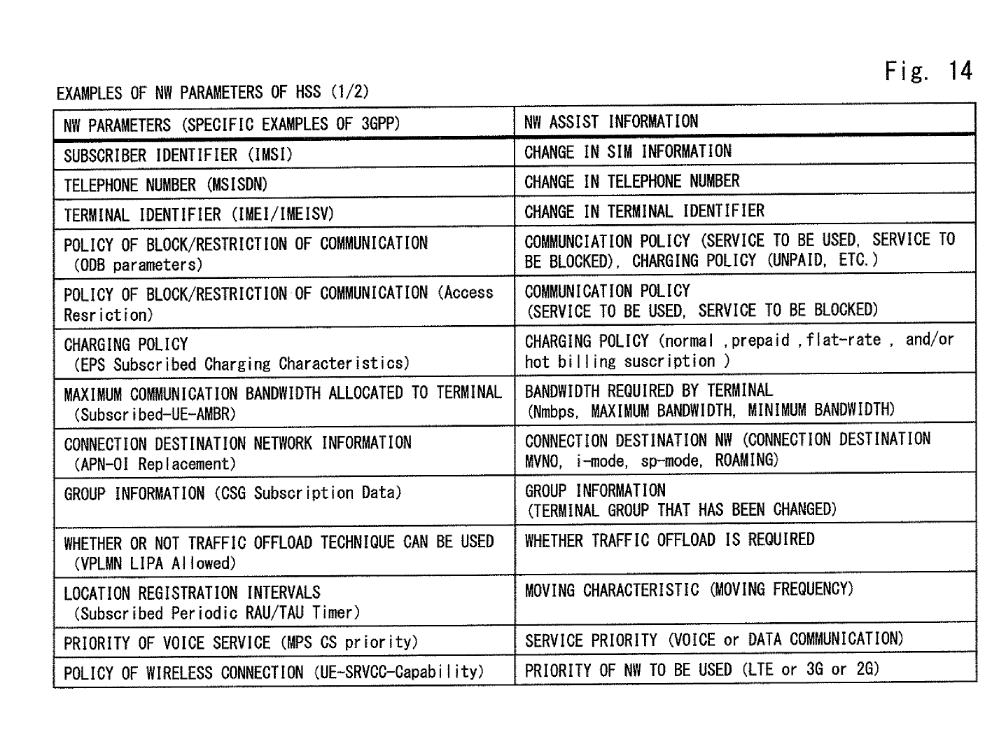

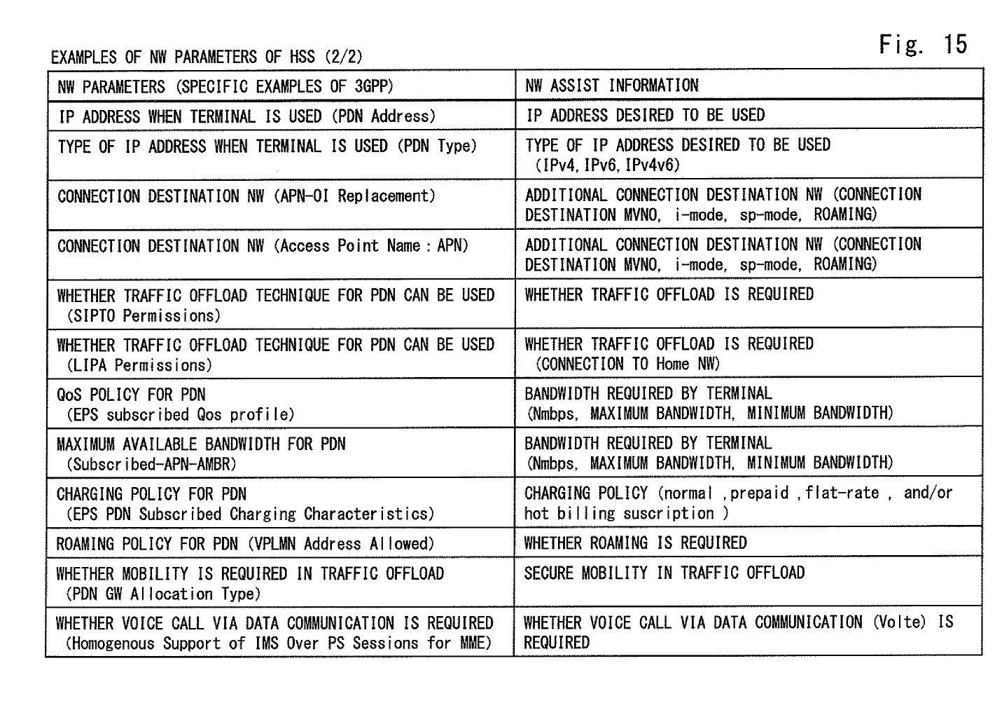

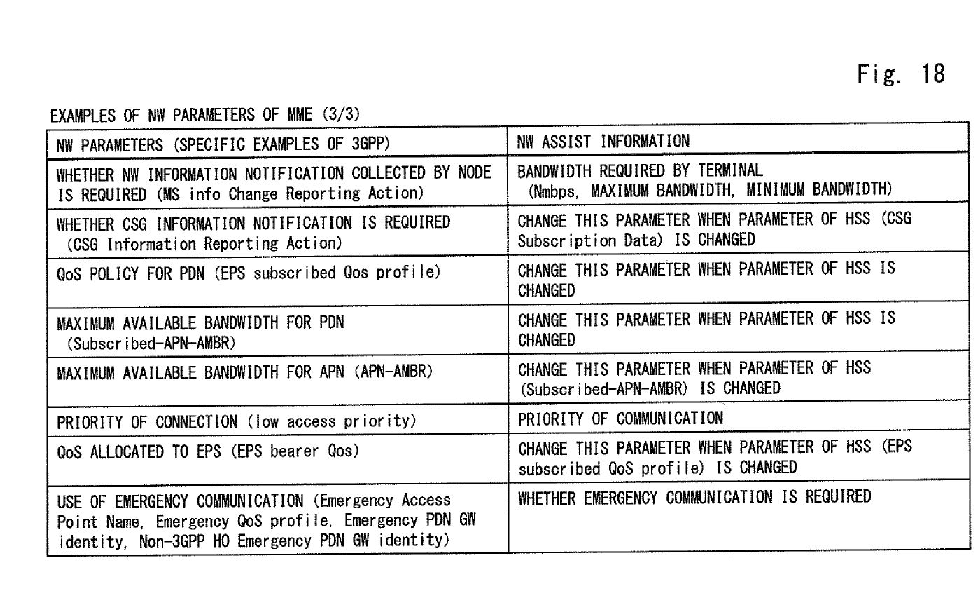

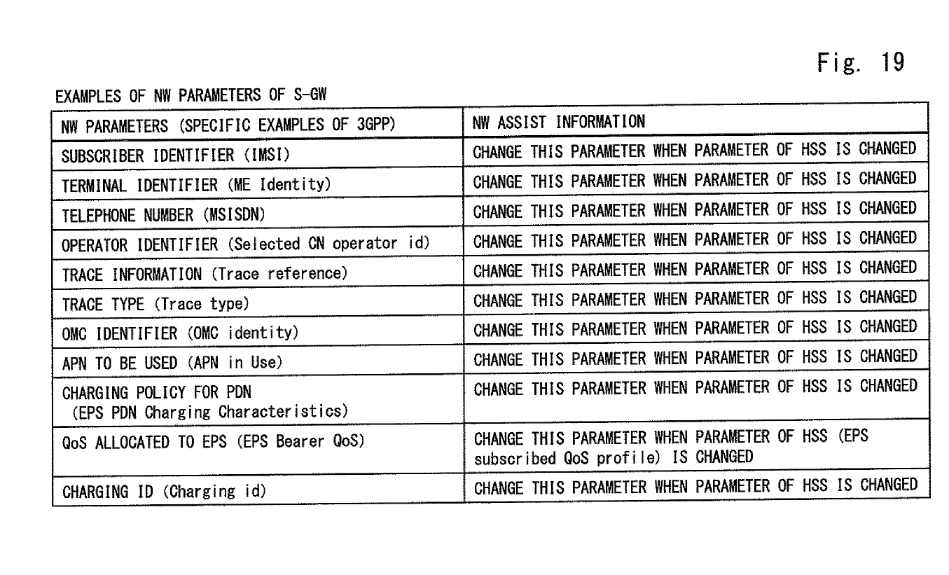

With reference to FIGS. 14 to 23, examples of the network parameters held by the HSS 77, the MME 72, the S-GW 75, the P-GW 76, and the UE will be described.

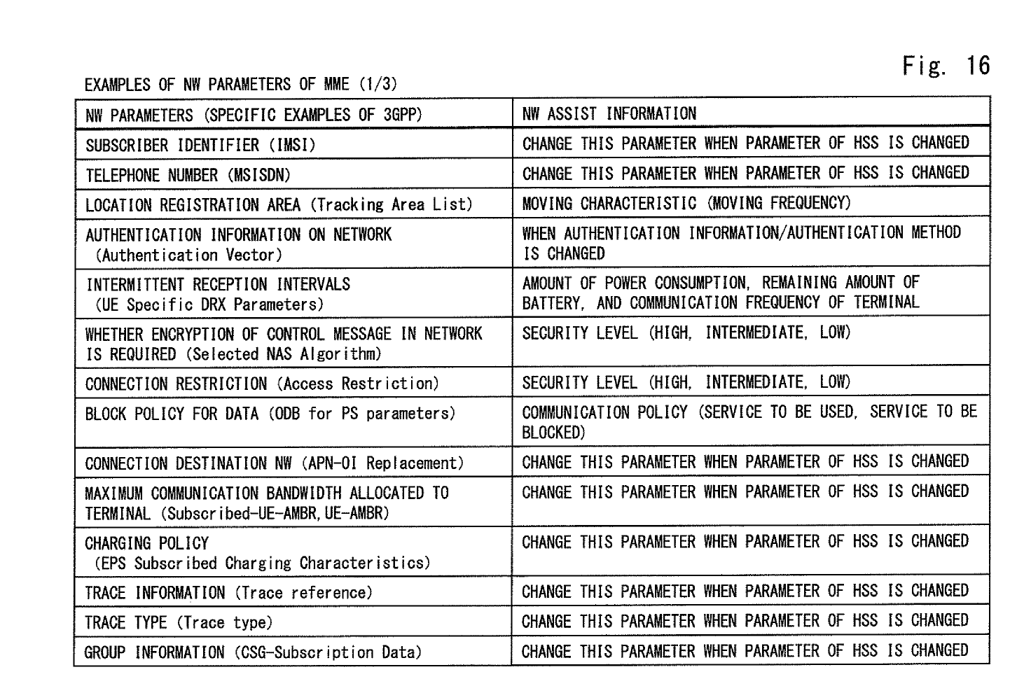

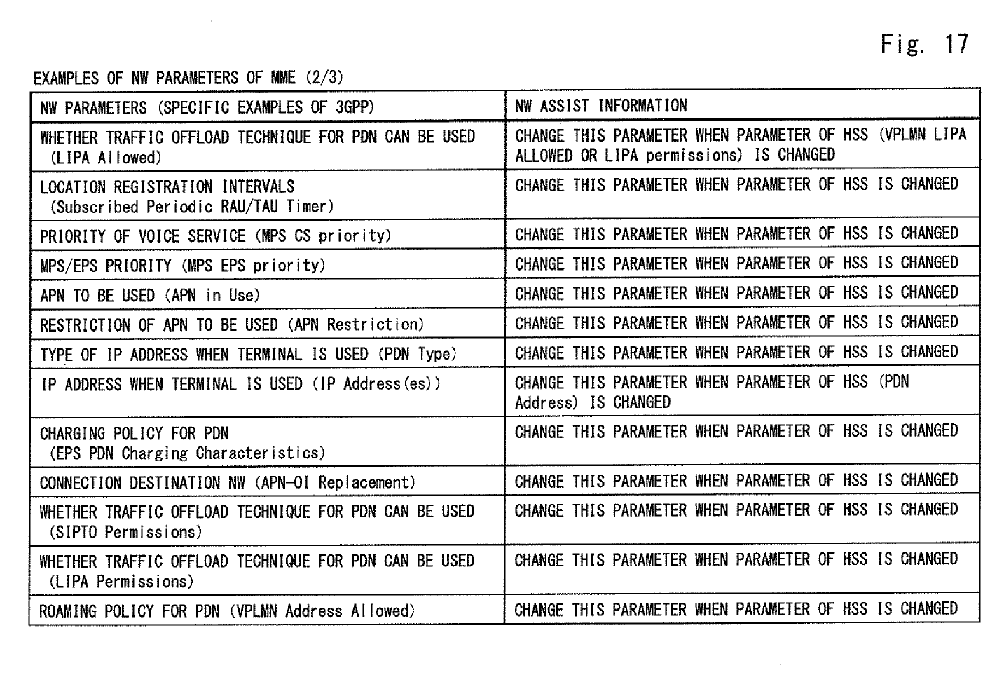

FIGS. 14 and 15 show lists of the network parameters held by the HSS 77. The left line in FIGS. 14 and 15 shows the list of the network parameters held by the HSS 77 and the right line in FIGS. 14 and 15 shows the network assist information used to change the network parameters so that the network assist information is associated with the network parameters. Further, the parameter in parentheses of each network parameter specifically shows the network parameter defined by the 3GPP. The network parameters defined by the 3GPP are disclosed, for example, in 3GPP TS23.401 V11.4.0 (2012 December). The tables shown in FIGS. 16 to 21 have a configuration similar to that of the tables shown in FIGS. 14 and 15.

When the MTC-IWF 73 receives information on the change in the SIM information as the network assist information, for example, the MTC-IWF 73 causes the HSS 77 to change the subscriber identifier (IMSI). Other network parameters are shown in FIGS. 14 and 15.

FIGS. 16 to 18 show lists of the network parameters held by the MME 72. For example, when the MTC-IWF 73 receives information regarding the security level as the network assist information, the MTC-IWF 73 causes the MME 72 to change a determination regarding whether the control message in the network needs to be encrypted (Selected NAS Algorithm). Other network parameters are shown in FIGS. 16 to 18. Further, the subscriber identifier (IMSI) held by the MME 72 is changed when the corresponding network parameter in the HSS 77 is changed. The network parameter regarding which it is defined in the network assist information that this parameter should also be changed when the parameter of the HSS is changed is changed in a similar way as in the subscriber identifier (IMSI).

Besides UE-AMBR, LIPA Allowed, APN in Use, APN Restriction being changed when the corresponding network parameters in the HSS 77 have been changed, they may be changed also when the MTC-IWF 73 has received the relevant network assist information.

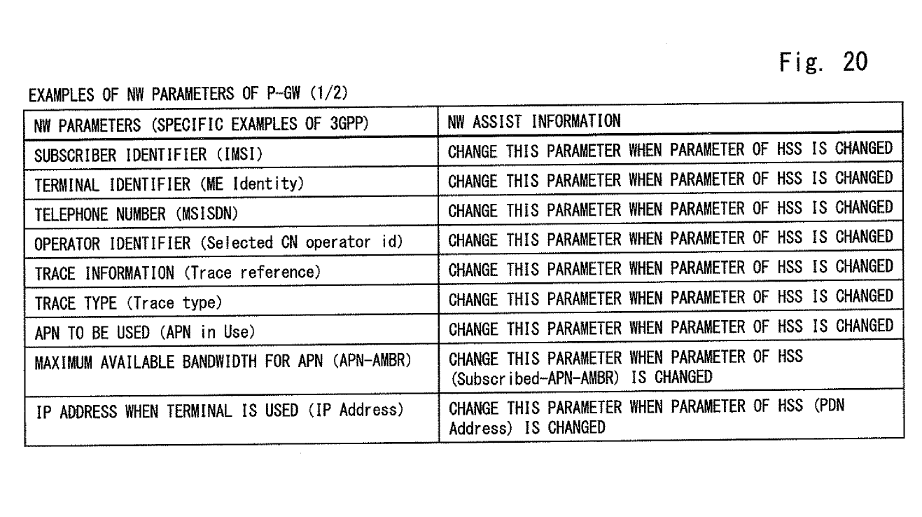

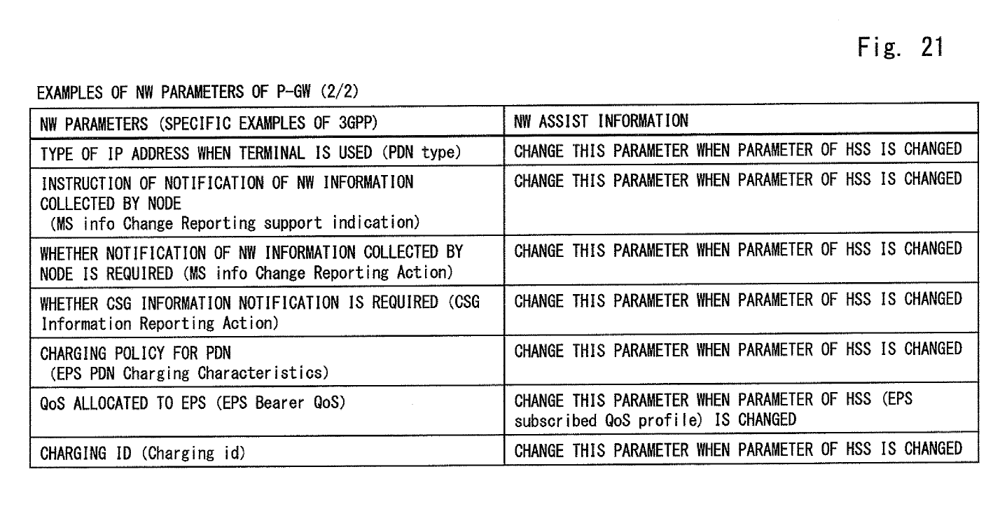

FIG. 19 shows a list of the network parameters held by the S-GW 75. Further, FIGS. 20 and 21 show lists of the network parameters held by the P-GW 76. The network parameters held by the S-GW 75 and the P-GW 76 are changed when the corresponding network parameters in the HSS 77 are changed.

Besides APN in Use, MS Info Change Reporting support indication, and MS Info Change Reporting Action being changed when the corresponding network parameters in the HSS 77 have been changed, they may be changed also when the MTC-IWF 73 has received the relevant network assist information.

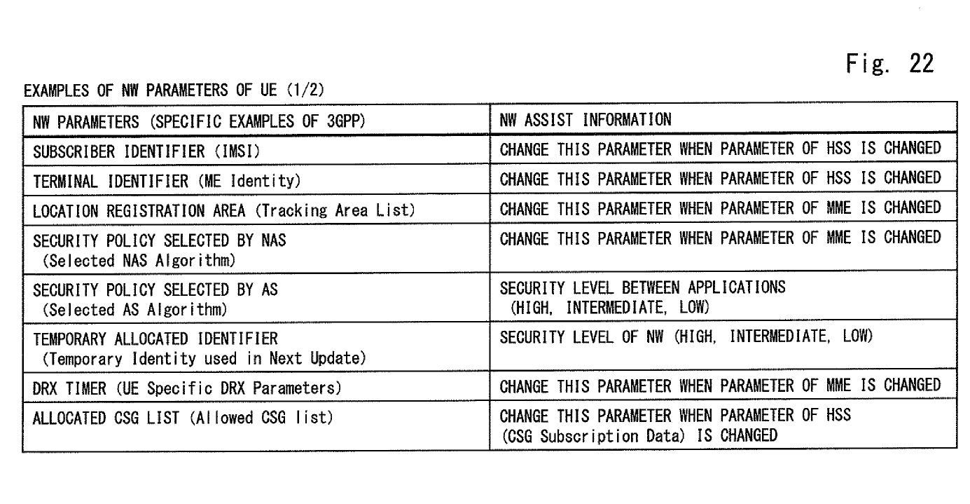

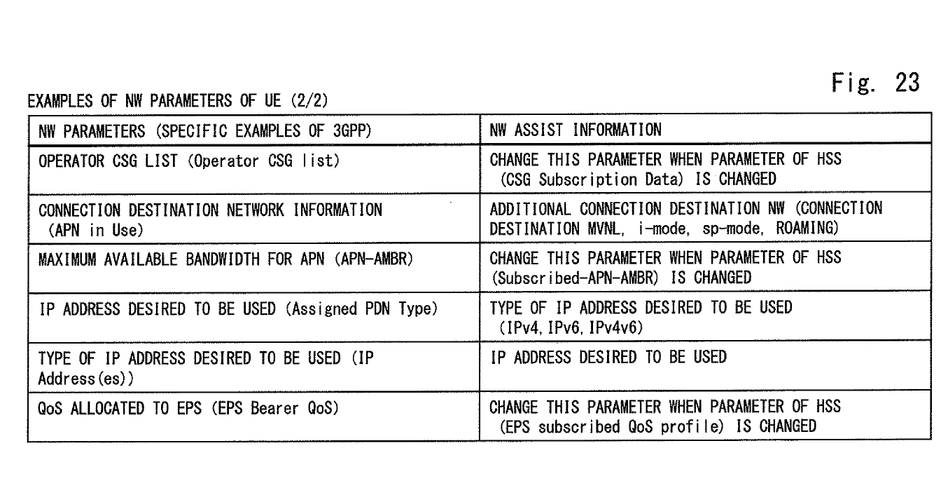

FIGS. 22 and 23 show lists of the network parameters held by the UE. For example, when the MTC-IWF 73 receives information regarding the network security level as the network assist information, the MTC-IWF 73 causes the UE to change a temporary allocated identifier (Temporary Identity used in Next Update). Other network parameters are shown in FIGS. 22 and 23. Further, the network parameter regarding which it is defined in the network assist information that this parameter should also be changed when the parameter of the HSS is changed is changed when the corresponding network parameter in the HSS 77 is changed. In a similar way, the network parameter regarding which it is defined in the network assist information that this parameter should also be changed when the parameter of the MME is changed is changed when the corresponding network parameter in the MME 72 is changed.

While the present invention has been described as a hardware configuration in the aforementioned exemplary embodiments, the present invention is not limited thereto. The present invention may achieve the processing of the mobile communication device by causing a Central Processing Unit (CPU) to execute a computer program.

In the above examples, the program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present invention is not limited to the aforementioned exemplary embodiments and may be changed as appropriate without departing from the spirit of the present invention.

While the present invention has been described above with reference to the exemplary embodiments, the present invention is not limited to the above exemplary embodiments. Various changes that can be understood by those skilled in the art may be performed on the configurations and the details of the present invention within the scope of the present invention.

This application is based upon and claims the benefit of priority from Japanese Patent Application No. 2013-28459, filed on Feb. 15, 2013, the disclosure of which is incorporated herein in its entirety by reference.

### REFERENCE SIGNS LIST

11 MOBILE COMMUNICATION DEVICE
12 NETWORK OPERATOR DEVICE
21 M2M DEVICE
23 NW NODE
25 NW PARAMETER MANAGEMENT DEVICE
26 NW CONTROL DEVICE
31 SENSOR
32 COMMUNICATION UNIT
33 CHARACTERISTIC CHANGE DETECTION UNIT
71 RADIO ACCESS NW DEVICE
72 MME
73 MTC-IWF
74 SCS
75 S-GW
76 P-GW
77 HSS
78 PCRF

1. A communication system comprising a network operator device that is arranged in a communication network managed by a communication provider and a communication device that performs communication via the communication network, wherein:
the communication device transmits network assist information to the network operator device, the network assist information being used to change network processing or a network parameter associated with the communication device upon detecting a state change in the communication device, and
the network operator device changes the network parameter associated with the communication device based on the network assist information transmitted from the communication device.

2. The communication system according to claim 1, wherein:
the communication network is a mobile communication network; and
the communication device is a mobile communication device.

3. The communication system according to claim 2, wherein the mobile communication device transmits the network assist information to the network operator device using a control message.

4. The communication system according to claim 2, wherein the information indicating the state change in the mobile communication device is an activation state of an engine when the mobile communication device is an automobile.

5. The communication system according to claim 2, wherein the information indicating the state change in the mobile communication device is sensor information detected by a sensor included in the mobile communication device.

6. The communication system according to claim 2, wherein the information indicating the state change in the mobile communication device is information indicating a change in a battery capacity of the mobile communication device.

7. The communication system according to claim 2, wherein the information indicating the state change in the mobile communication device is information indicating a change in an activation state of an application that operates in the mobile communication device.

8. The communication system according to claim 2, wherein the network assist information is used to change a communication resource to be allocated to the mobile communication device.

9. The communication system according to claim 2, wherein the network parameter comprises at least one of information regarding an area where the mobile communication device is called when incoming call processing for the mobile communication device is carried out, information on a timing for disconnecting the mobile communication device from the mobile communication network, information on a timing to perform communication with the mobile communication device, and information on a communication band to be allocated to the mobile communication device.

10. The communication system according to claim 2, wherein the mobile communication device transmits to the network operator device the network assist information used to change a network policy associated with the mobile communication device in the network operator device according to a change in needs or a utilization policy by a user that uses the mobile communication device.

11. A communication device that communicates with a network operator device via a communication network, the network operator device being arranged in the communication network managed by a communication provider,
wherein the communication device comprises a communication unit that transmits network assist information to the network operator device, the network assist information being used to change a network parameter associated with the communication device upon detecting a state change in the communication device.

12. A network parameter control method comprising transmitting network assist information to a network operator device, the network assist information being used to change a network parameter associated with a communication device in the network operator device arranged in a communication network according to a state change in the communication device that communicates with the network operator device via the communication network managed by a communication provider.

13. A non-transitory computer readable medium storing a program for causing a computer to execute a step of transmitting network assist information to a network operator device, the network assist information being used to change a network parameter associated with a communication device in the network operator device arranged in a communication network according to a state change in the communication device that communicates with the network operator device via the communication network managed by a communication provider.
